(19) United States
(12) Patent Application Publication
(10) Pub. No.: US 2026/0099164 A1
(43) Pub. Date: Apr. 9, 2026

(54) CAPACITOR-LESS LOW-DROPOUT REGULATOR WITH DYNAMIC FREQUENCY COMPENSATION

(71) Applicant: TAIWAN SEMICONDUCTOR MANUFACTURING COMPANY LTD., HSINCHU (TW)

(72) Inventors: WEI-LIN LAI, HSINCHU CITY (TW); BEI-SHING LIEN, TAIPEI CITY (TW); SZU-LIN LIU, HSINCHU CITY (TW)

(21) Appl. No.: 19/050,140

(22) Filed: Feb. 11, 2025

Related U.S. Application Data
(60) Provisional application No. 63/703,482, filed on Oct. 4, 2024.

(51) Int. Cl. G05F 1/575

(52) U.S. Cl. CPC G05F 1/575

(57) ABSTRACT

A voltage regulator circuit is provided, which includes an input stage, a transconductance compensation stage, a driving stage, and a feedback circuit. The input stage is configured to compare a reference voltage and a feedback voltage to generate a first voltage at a first output terminal of the input stage. The transconductance compensation stage is configured to change an overall transconductance of the input stage in response to a change in the feedback voltage. The driving stage is coupled between the first output terminal and a second output terminal of the voltage regulator circuit, and is configured to provide a driving current to the second output terminal which is coupled to a load. The feedback circuit is coupled to the second output terminal, and is configured to generate the feedback voltage based on an output voltage of the voltage regulator circuit.

### CROSS-REFERENCE TO RELATED APPLICATION(S)

This application claims the benefit of U.S. Provisional Application No. 63/703,482, filed Oct. 4, 2024, the entire disclosure of which is incorporated by reference herein.

### BACKGROUND

A low-dropout (LDO) voltage regulator provides a specified and stable direct-current (DC) output voltage (e.g., a regulated output voltage) based on an input voltage (e.g., an unregulated input voltage) with a low dropout voltage. The “dropout voltage” used herein refers to a minimum voltage across the (LDO) voltage regulator to maintain the output voltage being regulated. Even though the input voltage, provided by a power source, falls to a level very near that of the output voltage and is unregulated, the LDO voltage regulator can still produce the output voltage that is regulated and stable. Such a stable characteristic enables the LDO voltage regulator to be used in a variety of integrated circuit (IC) applications, for example, a memory device, a power IC device, etc.

### BRIEF DESCRIPTION OF THE DRAWINGS

Aspects of the present disclosure are best understood from the following detailed description when read with the accompanying figures. It is emphasized that, in accordance with standard practice in the industry, various features are not drawn to scale. In fact, the dimensions of the various features can be arbitrarily increased or reduced for clarity of discussion.

FIG. 1 is a block diagram of a low-dropout regulator in accordance with some embodiments of the present disclosure.

FIG. 2 is a schematic diagram of the low-dropout regulator in accordance with the embodiment of FIG. 1.

FIG. 3A is a schematic diagram of the LDO regulator 100A in FIG. 2 before the dynamic frequency compensation.

FIG. 3B is a schematic diagram of the small-signal models at output terminals of different stages within the LDO regulator 100A in FIG. 3A.

FIG. 3C is a Bode plot illustrating the poles of the LDO regulator 100A in FIG. 3A.

FIG. 4A is a schematic diagram of the LDO regulator 100A in FIG. 2 after the dynamic frequency compensation.

FIG. 4B is a schematic diagram of the small-signal models at output terminals of different stages within the LDO regulator 100A in FIG. 4A.

FIG. 4C is a Bode plot illustrating the poles of the LDO regulator 100A in FIG. 4A.

FIG. 5A illustrates Bode plots for the magnitude and phase with respect to the frequency in some frequency compensation approaches.

FIG. 5B illustrates Bode plots for the magnitude and phase with respect to the frequency in accordance with the embodiments of FIGS. 2 to 4.

FIG. 6 is another schematic diagram of the low-dropout regulator in accordance with the embodiment of FIG. 1.

FIG. 7 is a flowchart of a method for operating a low-dropout regulator in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features can be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Further, it will be understood that when an element is referred to as being “connected to” or “coupled to” another element, it can be directly connected to or coupled to the other element, or intervening elements can be present.

Embodiments, or examples, illustrated in the drawings are disclosed as follows using specific language. It will nevertheless be understood that the embodiments and examples are not intended to be limiting. Any alterations or modifications in the disclosed embodiments, and any further applications of the principles disclosed in this document are contemplated as would normally occur to one of ordinary skill in the pertinent art.

Further, it is understood that several processing steps and/or features of a device can be only briefly described. Also, additional processing steps and/or features can be added, and certain of the following processing steps and/or features can be removed or changed while still implementing the claims. Thus, it is understood that the following descriptions represent examples only, and are not intended to suggest that one or more steps or features are required.

In addition, the present disclosure may repeat reference numerals and/or letters in the various examples. This repetition is for the purpose of simplicity and clarity and does not in itself dictate a relationship between the various embodiments and/or configurations discussed.

In the following embodiments, the terms “angular frequency” (e.g., in units of rad/sec) and “frequency” (e.g., in units of Hertz) are used to describe the relationship between the different poles within the LDO regulator. Unless specifically specified, the terms “angular frequency” and “frequency” can be used interchangeably, and they may both refer to the angular frequency of a pole. Source/drain region(s) may refer to a source or a drain, individually or collectively dependent upon the context.

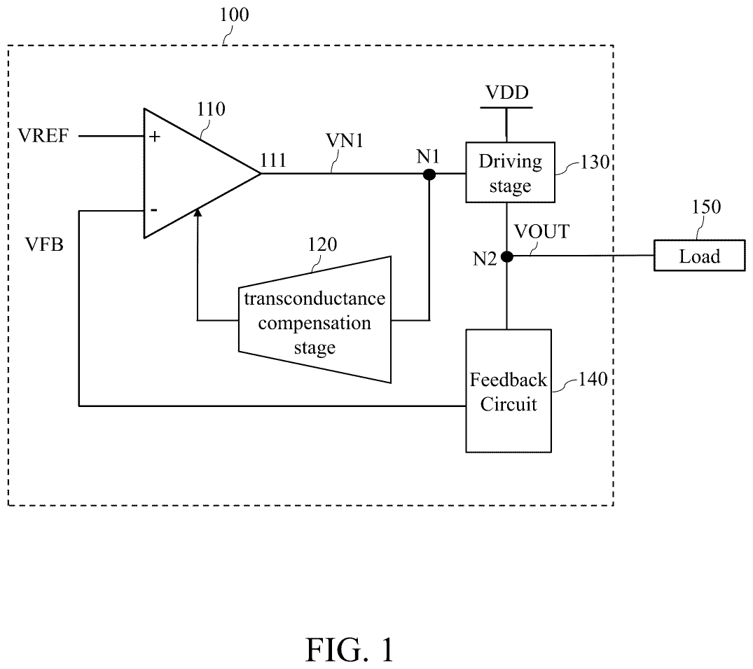

FIG. 1 is a block diagram of a low-dropout regulator in accordance with some embodiments of the present disclosure.

In some embodiments, the low-dropout (LDO) regulator 100, which is also referred to as a voltage regulator circuit, includes an the input stage 110, a transconductance compensation stage 120, a driving stage 130, and a feedback circuit 140, as depicted in FIG. 1. The input stage 110 includes an inverting input terminal (e.g., “-”) and a non-inverting input terminal that receives a reference voltage VREF and a feedback voltage V_{FB}, respectively. The input stage 110 further includes an output terminal 111 that is connected to an internal node N2 of the LDO regulator 100. In some embodiments, the input stage 110 is configured to compare the reference voltage VREF and the feedback voltage V_{FB} to generate a voltage signal VN1 at its output terminal 111.

In some embodiments, the input stage 110 can be implemented using a differential amplifier, an operational amplifier, an operational transconductance amplifier, an error amplifier, or any other equivalent circuit, but the present disclosure is not limited thereto. In some embodiments, the input stage 110 can also be referred to as an input power supply rejection ratio (PSRR) stage. In some embodiments, the feedback circuit 140 is configured to assist in maintaining the output voltage VOUT of the LDO regulator 100 at a substantially stable value while various levels of load 150 are coupled to the output terminal (e.g., node N2) of the LDO regulator. For example, the feedback circuit 140 is configured to provide the feedback voltage V_{FB} to the input stage 110 based on the voltage level of the output voltage VOUT. In some embodiments, the feedback circuit 140 may be implemented using a voltage divider, which may include one or more resistors, potentiometers, diodes, Zener diodes, or any combination thereof, but the present disclosure is not limited thereto.

In some embodiments, the voltage signal VN1 generated by the input stage 110 is sent to the driving stage 130, allowing the driving stage 130 to generate an output voltage VOUT at its output terminal (e.g., node N2). In some embodiments, the reference voltage VREF may be provided by a power source (e.g., a battery, not shown) that may be unregulated. The voltage level of the output voltage VOUT may be lower than that of the reference voltage VREF by a small amount, (e.g., from approximately 100 mV to IV), which is referred to as the dropout voltage of the LDO regulator 100. The output terminal (e.g., node N2) is coupled to a load 150, which may be a functional circuitry of an integrated circuit.

Additionally, the voltage signal VN1 generated by the input stage 110 is fed back to the input stage 110 through the transconductance compensation stage 120. The transconductance compensation stage 120 can also be referred to as a dynamic frequency compensation stage configured to adjust the overall transconductance (gₘ) of the input stage 110, thereby moving the second pole of the LDO regulator 100 to a higher frequency while maintaining the phase margin of the LDO regulator 100 after the dynamic frequency compensation, the details of which will be described later.

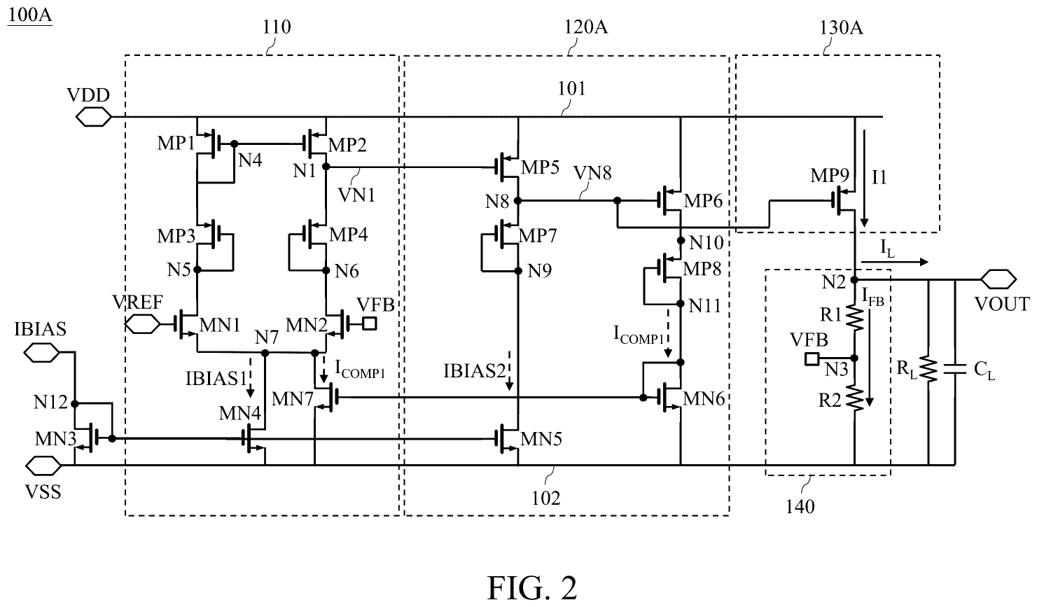

FIG. 2 is a schematic diagram of the low-dropout regulator in accordance with the embodiment of FIG. 1.

In some embodiments, the LDO regulator 100 shown in FIG. 1 can be implemented using the LDO regulator 100A shown in FIG. 2. The LDO regulator 100A includes an the input stage 110, a transconductance compensation stage 120A, a driving stage 130A, and a feedback circuit 140, as depicted in FIG. 2. For illustrative purposes, the LDO regulator 100A includes transistors MP1 to MP9 and MN1 to MN7, where transistors MP1 to MP4 may be P-type transistors, and transistors MN1 to MN2 may be N-type transistors. For example, the input stage 110 is implemented using a differential amplifier, including a first current source, a second current source, and transistors MP1 to MP4 and MN1 to MN2. The differential amplifier is biased by both the first current source and the second current source, which refer to transistors MN4 and MN7, respectively.

As depicted in FIG. 2, transistor MN3 includes a gate terminal coupled to node N12, a first S/D terminal coupled to node N12, and a second S/D terminal coupled to power rail 102 for the power supply voltage VSS, while transistor MN4 includes a gate terminal coupled to node N12, a first S/D terminal coupled to node N7, and a second S/D terminal coupled to power rail 102. In some embodiments, transistors MN3 and MN4 may be substantially identical, and they form a current mirror, which is biased by a bias current IBIAS. Accordingly, the bias current IBIAS flowing through transistor MN3 is mirrored by transistor MN4, which has a gate-to-source voltage substantially equal to that of transistor MN3, and serves as the first current source for the input stage 110. In some embodiments, the transistor sizes of MN3 and MN4 can differ, and the bias current provided by transistor MN4 (e.g., the first current source) can be determined according to the ratio of the transistor sizes of transistors MN3 and MN4. Here, the transistor size may refer to a channel width of a planar field-effect transistor (FET), a number of fins of a finFET, or a number of channels or nanosheets of a nanosheet FET.

Similarly, transistors MN6 and MN7 may be substantially identical, and they form another current mirror, which is biased by a bias current I_{comp1}. For example, transistor MN6 includes a gate terminal coupled to node N11, a first S/D terminal coupled to node N11, and a second S/D terminal coupled to power rail 102, while transistor MN7 includes a gate terminal coupled to node N11, a first S/D terminal coupled to node N7, and a second S/D terminal coupled to power rail 102. Accordingly, the bias current I_{comp1} flowing through transistor MN6 is mirrored by transistor MN7, which has a gate-to-source voltage substantially equal to that of transistor MN7, and serves as the second current source for the input stage 110. In some embodiments, the transistor sizes of MN6 and MN7 can differ, and the bias current provided by transistor MN7 (e.g., the second current source) can be determined according to the ratio of the transistor sizes of transistors MN6 and MN7.

For example, transistor MP1 includes a gate source coupled to node N4, a first source/drain (S/D) terminal coupled to power rail 101 for the power supply voltage VDD, and a second S/D terminal coupled to node N4, while transistor MP2 includes a gate terminal coupled to node N4, a first S/D terminal coupled to power rail 101, and a second S/D terminal coupled to node N1. Additionally, transistor MP3 includes a gate terminal coupled to node N5, a first S/D terminal coupled to node N4, and a second S/D terminal coupled to node N5, while transistor MP4 includes a gate terminal coupled to node N6, a first S/D terminal coupled to node N1, and a second S/D terminal coupled to node N6. Furthermore, transistor MN1 includes a gate terminal receiving the reference voltage VREF, a first S/D terminal coupled to node N5, and a second S/D terminal coupled to node N7, while transistor MN2 includes a gate terminal receiving the feedback voltage V_{FB} generated by the feedback circuit 140, a first S/D terminal coupled to node N6, and a second S/D terminal coupled to node N7.

In some embodiments, the transconductance compensation stage 120A is coupled between the input stage 110 and the driving stage 130A. The transconductance compensation stage 120A includes transistors MP5 to MP8 and transistors MN5 to MN6. For example, transistor MP5 includes a gate terminal coupled to node N1 (e.g., output terminal of the input stage 110), a first S/D terminal coupled to power rail 101, and a second S/D terminal coupled to node N8, while transistor MP6 includes a gate terminal coupled to node N8, a first S/D terminal coupled to power rail 101, and a second S/D terminal coupled to node N10. Additionally, transistor MP7 includes a gate terminal coupled to node N9, a first S/D terminal coupled to node N8, and a second S/D terminal coupled to node N9, while transistor MP8 includes a gate terminal coupled to node N11, a first S/D terminal coupled to node N10, and a second S/D terminal coupled to node N11. Furthermore, transistor MN5 may serve as a current source for transistors MP5 and MP7, while the compensation current ICOMP1 flowing through transistor MN6 is mirrored by transistor MN7.

In some embodiments, transistors MN3 and MN5 form yet another current mirror, and the bias current IBIAS flowing through transistor MN3 is mirrored by transistor MN5. Because transistors MN3 and MN5 have the same gate-to-source voltages, the mirrored bias current IBIAS2 equals the bias current IBIAS when transistor MN3 matches transistor MN5 (e.g., with substantially the same transistor size), or can be determined by the ratio of transistors sizes of transistors MN3 and MN5 when transistor MN3 does not match transistor MN5. Additionally, transistors MN6 and MN7 form yet another current mirror, and the compensation current ICOMP1 flowing through transistor MN6 is mirrored by transistor MN7. Because transistors MN6 and MN7 have the same gate-to-source voltages, the mirrored compensation current ICOMP2 equals the compensation current ICOMP1 when transistor MN6 matches transistor MN7 (e.g., with substantially the same transistor size), or can be determined by the ratio of transistors sizes of transistors MN6 and MN7 when transistor MN6 does not match transistor MN7.

In some embodiments, the driving stage 130A includes transistor MP9, which includes a gate terminal coupled to node N8, a first S/D terminal coupled to power rail 101, and a second S/D terminal coupled to node N2 (e.g., output terminal of the LDO regulator 100). The activation of transistor MP9 is determined based on the voltage VN8 at node N8, as the activation of transistor MP5 is determined based on the voltage VN1 at node N1. For example, when the voltage VN1 is in a low logic state, transistor MP5 is activated, pulling up the voltage VN8 at node N8 to the power supply voltage VDD. When the voltage VN1 is in a high logic state, transistor MP5 is deactivated, and the voltage VN8 at node N8 is pulled down to the power supply voltage VSS through transistors MP7 and MN5. Accordingly, when the voltage VN8 at node N8 is substantially equal to the power supply voltage VDD, transistor MP9 is deactivated, and the output voltage VOUT at node N3 is pulled down to the power supply voltage VSS through resistors R1 and R2 of the feedback circuit 140. When the voltage VN8 at node N8 is substantially equal to the power supply voltage VSS, transistor MP9 is activated, pulling up the output voltage VOUT at node N3 to the power supply voltage VDD.

In some embodiments, the driving devices within the transconductance compensation stage 120A and the driving stage 130A of the LDO regulator 100A, such as transistors MP5, MP6, and MP9, include P-type transistors. Additionally, the transconductance compensation stage 120A includes a first stage and a second stage. For example, the first stage includes transistors MP5, MP7, and MN5, while the second stage includes transistors MP6, MP8, and MN6.

It should be noted that when transistor MP9 is activated, a current I1 flows through transistor MP9, and it is divided into a load current Iload and a feedback current I_{FB} at node N2. The load current Iload may flow into the load 150 shown in FIG. 1, which is represented by the load capacitance C_{L}, as depicted in FIG. 2. Additionally, since the feedback current IFB flows through resistors R1 and R2, the feedback voltage provided at node N3 can be expressed by formula (1) as follows.

$${V}_{FB} = \frac{R 2}{R 1 + R 2} \times {V}_{OUT} \qquad ( 1 )$$

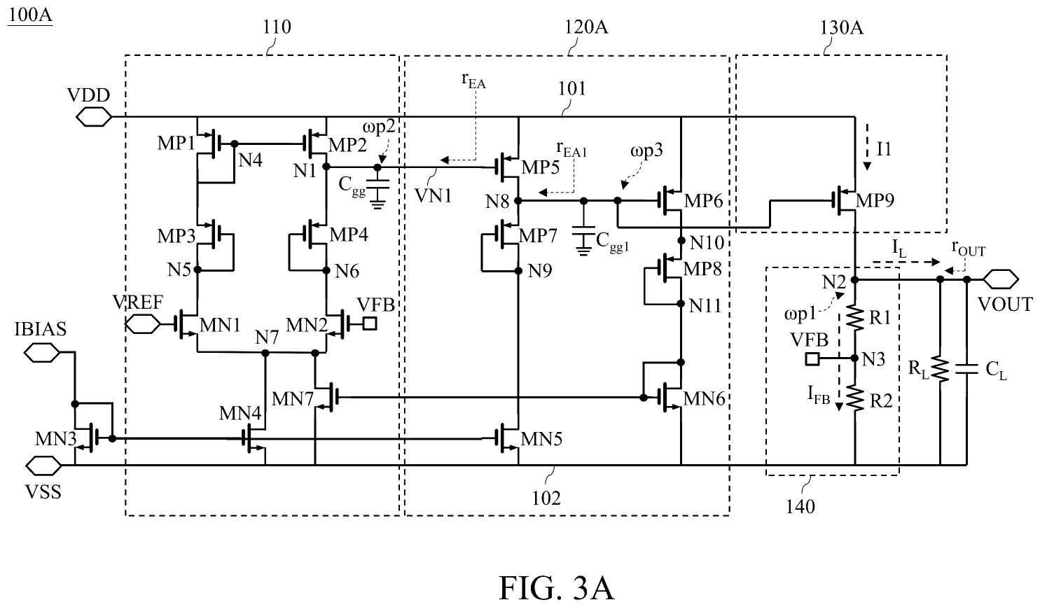

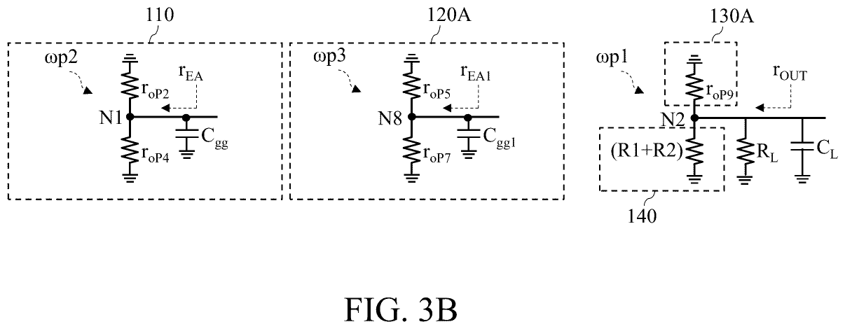

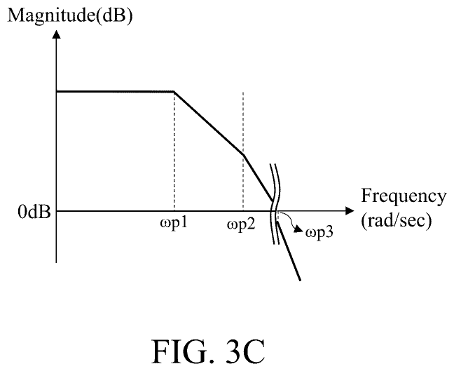

Furthermore, the feedback voltage V_{FB} is fed back to one input terminal of the input stage 110 (e.g., gate terminal of transistor MN2), thus forming a negative feedback loop, the details of which will be described with reference to FIGS. 3 to 5. Additionally, the ratio of R2/(R1+R2) can be regarded as a feedback factor of the feedback circuit 140.

FIG. 3A is a schematic diagram of the LDO regulator 100A in FIG. 2 before the dynamic frequency compensation. FIG. 3B is a schematic diagram of the small-signal models at output terminals of different stages within the LDO regulator 100A in FIG. 3A. FIG. 3C is a Bode plot illustrating the poles of the LDO regulator 100A in FIG. 3A.

For purposes of description, the locations associated with three poles of the LDO regulator 100A before dynamic frequency compensation are illustrated on FIG. 3A, such as poles ωp1, ωp2, and ωp3 (e.g., angular frequencies) associated with equivalent output resistance and equivalent capacitance at nodes N2, N1, and N8, respectively.

For purposes of description, A_{EA}, T_{EA}, g_{mEA}, and C_{gg} denote the gain, output resistance, transconductance, and equivalent parasitic capacitance of the small-signal model of the input stage 110, respectively. The gain A_{EA} of the input stage 110 can be expressed as A_{EA}≅g_{mEA}r_{EA}. For brevity, the output resistance r_{EA} of the input stage 110 can be simplified as: r_{EA}=r_{oP2}//r_{oP4}, where r_{oP2} and r_{oP4} denote the small-signal output resistance of transistors MP2 and MP4, respectively, as depicted in FIG. 3B.

Additionally, A_{EA1}, T_{EA1}, g_{mEA1}, and C_{gg1} denote the gain, output resistance, transconductance, and equivalent parasitic capacitance of the small-signal model of the transconductance compensation stage 120A, respectively. The gain A_{EA1} of the transconductance compensation stage 120A can be expressed as: A_{EA1}≅g_{mEA1}r_{EA1}. The output resistance r_{EA1} of the transconductance compensation stage 120A can be simplified as: r_{EA1}=r_{oP5}//r_{oP7}, where r_{oP5} and r_{oP7} denote the small-signal output resistance of transistors MP5 and MP7, respectively, as depicted in FIG. 3B.

Furthermore, A_{OUT} denotes the gain of the driving stage 130A (e.g., transistor MP9), Imp denotes the transconductance of transistor MP9, and B denotes the feedback factor of the feedback circuit 140, where the feedback factor β can be expressed as

$$β = \frac{R 2}{R 1 + R 2} .$$

The overall DC gain A_{LDO} of the LDO regulator 100A can be calculated as A_{LDO}=A_{EA}A_{EA1}A_{OUT}, where A_{OUT}≅gₘₚr_{OUT}. Since the LDO regulator 100A includes a negative feedback loop with the feedback factor β, the transfer function T(s) of the LDO regulator 100A can be expressed using formula (2) as follows.

$$T ( s ) = {A}_{EA} {A}_{EA 1} {A}_{OUT} β \frac{1}{( 1 + \frac{1}{ω p 1} ) ( 1 + \frac{1}{ω p 2} ) ( 1 + \frac{1}{ω p 3} )} = ( {g}_{mEA} {r}_{EA} ) ( {g}_{mEA 1} {r}_{EA 1} ) ( {g}_{mp} {r}_{OUT} ) β \frac{1}{( 1 + \frac{1}{ω p 1} ) ( 1 + \frac{1}{ω p 2} ) ( 1 + \frac{1}{ω p 3} )} \qquad ( 2 )$$

In some embodiments, the bandwidth of the LDO regulator 100A before the dynamic frequency compensation can be approximately determined by the dominant pole ωp1, which is associated with the equivalent resistance and equivalent capacitance at node N2. For example, the dominant pole ωp1 of the LDO regulator 100A can be expressed as:

$$ω p 1 = \frac{1}{{r}_{OUT} \times {C}_{L}} .$$

For example, considering the small-signal model of the LDO regulator 100A, the output resistance r_{OUT1} at the output terminal of the LDO regulator 100A can be expressed by formula (3) as follows.

$${r}_{OUT 1} = {r}_{oP 9} / / ( R 1 + R 2 ) / / {R}_{L} \qquad ( 3 )$$

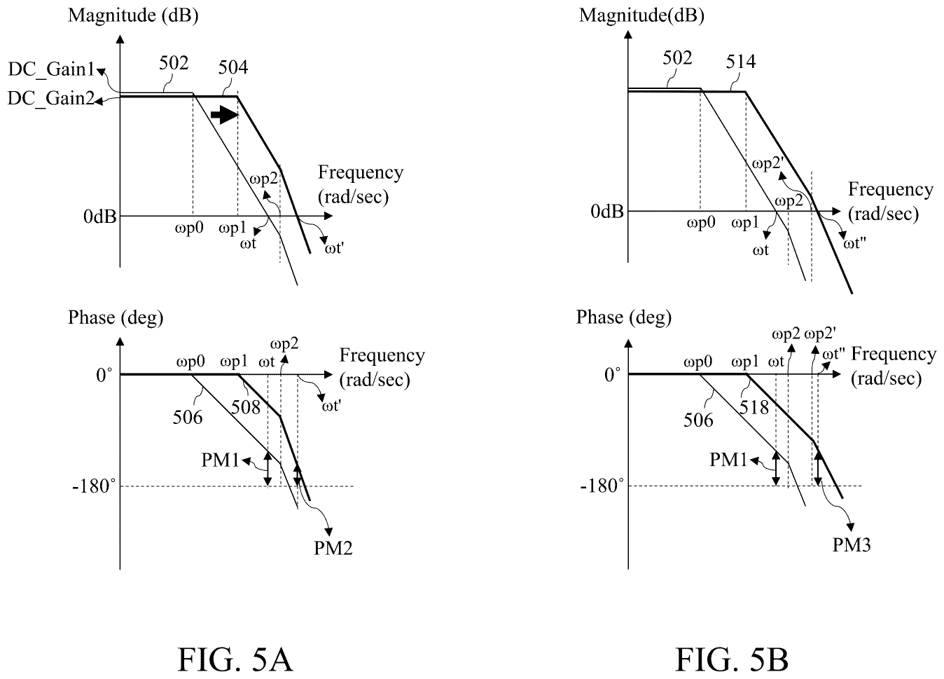

Referring to formula (2), r_{oP9} denotes the small-signal output resistance of transistor MP9, and R_{L} denotes the load resistance of load 150. Since the load capacitance C_{L} of load 150 is relatively large, the angular frequency (e.g., in units of rad/sec) of the dominant pole ωp1 is higher than the dominant pole ωp0 of a first LDO regulator utilizing the Miller compensation technique with a Miller capacitance, as shown in FIG. 5B.

In some embodiments, the second pole ωp2, which is associated with the output resistance r_{EA} and load resistance C_{gg} at node N1, can be expressed

$$ω p 2 = \frac{1}{{r}_{EA} \times {C}_{gg}} .$$

Similarly, the third pole ωp3, which is associated with the output resistance r_{EA1} and load resistance C_{gg1} at node N8, can be expressed as:

$$ω p 3 = \frac{1}{{r}_{EA 1} \times {C}_{gg 1}} .$$

In some embodiments, since the equivalent capacitance C_{gg1} of the transconductance compensation stage 120A is relatively smaller than the equivalent capacitance C_{gg} of the input stage 110, the angular frequency (or frequency) of the third pole ωp3 is relatively higher than that of the second pole ωp2. Accordingly, the relationship between the angular frequencies of the three poles ωp1, ωp2, and ωp3 of the LDO regulator 100A can be expressed as: ωp1<ωp2<<ωp3, as depicted in FIG. 3C.

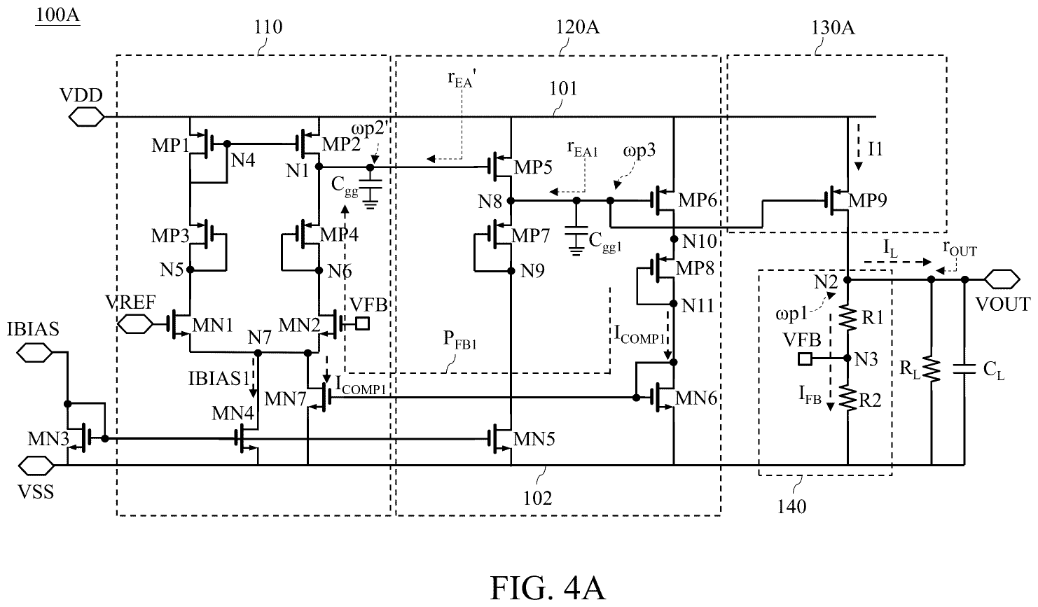

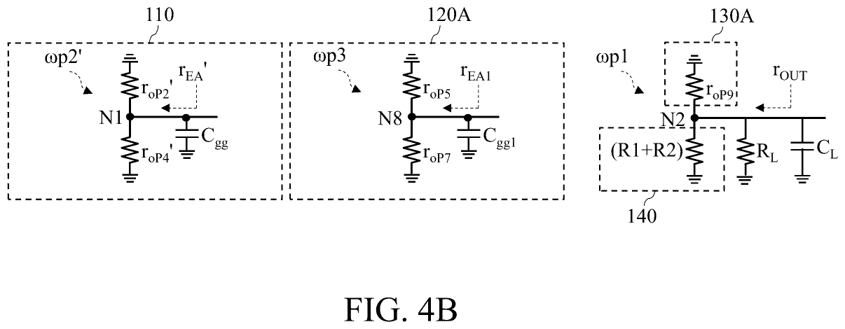

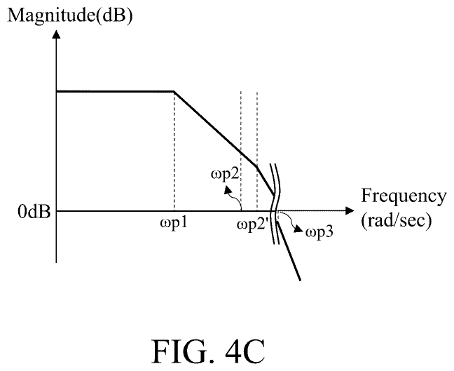

FIG. 4A is a schematic diagram of the LDO regulator 100A in FIG. 2 after the dynamic frequency compensation. FIG. 4B is a schematic diagram of the small-signal models at output terminals of different stages within the LDO regulator 100A in FIG. 4A. FIG. 4C is a Bode plot illustrating the poles of the LDO regulator 100A in FIG. 4A.

For purposes of description, the locations associated with three poles of the LDO regulator 100A after dynamic frequency compensation are illustrated on FIG. 4A, such as poles ωp1, ωp2′, and ωp3 (e.g., angular frequencies) associated with equivalent output resistance and equivalent capacitance at nodes N2, N1, and N8, respectively. FIG. 4A may be similar to FIG. 3A, with the difference being that r_{EA}′ represents the output resistance of the small-signal model of the input stage 110 after the dynamic frequency compensation, and PEBI denotes the dynamic frequency compensation path within the LDO regulator 100A.

The analysis of the negative feedback loop within the LDO regulator 100A is described as follows. First, referring to FIG. 2, transistor MP9 in the driving stage 130A provides a fixed driving current I1 when activated, and current I1 equals the load current I_{L} plus the feedback current I_{FB}, as shown in FIG. 4A. When the load current I_{L} at the output terminal of the LDO regulator 100A increases, the feedback current I_{FB} decreases, which reduces the feedback voltage V_{FB} at node N3. Subsequently, the reference voltage VREF becomes higher than the feedback voltage V_{FB}, turning on transistor MN1 and turning off transistor MN2. Accordingly, the voltage at node N4 is pulled down through transistors MP3 and MN1, turning on transistor MP2 and thereby increasing the voltage VN1 at node N1, which is the first S/D terminal of transistor MP2 and the output terminal of the input stage 110. This indicates that the gate voltage of transistor MP5 within the transconductance compensation stage 120A increases with the voltage VN1.

It should be noted that a higher gate voltage (e.g., voltage VN1 at node N1) of transistor MP5 induces a lower drain voltage (e.g., voltage VN8 at node N8) of transistor MP5, serving as the gate voltage of transistors MP6 and MP9. Additionally, a lower gate voltage of transistor MP9 induces a higher drain voltage (e.g., output voltage VOUT at node N2) of transistor MP9, increasing the feedback voltage V_{FB} at node N3. The aforementioned operations constitute a negative feedback loop, starting from a decreased feedback voltage V_{FB} due to the increasing load current I_{L}, and resulting in an increased feedback voltage V_{FB}.

On the other hand, when the load current I_{L} at the output terminal of the LDO regulator 100A decreases, the feedback current I_{FB} increases, which increases the feedback voltage V_{FB} at node N3. Subsequently, the reference voltage VREF becomes lower than the feedback voltage V_{FB}, turning off transistor MN1 and turning on transistor MN2. Accordingly, the voltage at node N1 is pulled down through transistors MP4 and MN2, turning off transistor MP2 and thereby decreasing the voltage VN1 at node N1, which is the first S/D terminal of transistor MP2 and the output terminal of the input stage 110. This indicates that the gate voltage of transistor MP5 within the transconductance compensation stage 120A decreases with the voltage VN1.

It should be noted that a lower gate voltage (e.g., voltage VN1 at node N1) of transistor MP5 induces a higher drain voltage (e.g., voltage VN8 at node N8) of transistor MP5, serving as the gate voltage of transistors MP6 and MP9. Additionally, a higher gate voltage of transistor MP9 induces a lower drain voltage (e.g., output voltage VOUT at node N2) of transistor MP9, decreasing the feedback voltage V_{FB} at node N3. The aforementioned operations also constitute a negative feedback loop, starting from an increased feedback voltage V_{FB} due to the increasing load current I_{L}, and resulting in a decreased feedback voltage V_{FB}.

More specifically, the compensation current ICOMP1 generated by the frequency compensation loop within the transconductance compensation stage 120A is fed back to the input stage 110 via transistor MN7 (e.g., the second current source for the input stage 110) along the feedback path P_{FB1}, increasing the overall transconductance gₘ of the input stage 110. For example, the overall bias current for the differential amplifier within the input stage 110 becomes the bias current IBIAS1 plus the compensation current I_{COMP1}. Since the output resistance r_{EA}′, along with the output resistances r_{oP2}′ and r_{oP4}′ of transistors MP2 and MP4 after the dynamic frequency compensation shown in FIG. 4B, are inversely proportional to the overall transconductance g_{mEA}, the output resistance r_{EA}′ of the input stage 110 decreases as the overall transconductance g_{mEA} of the input stage 110 increases. Given that g_{mEA}′ denotes the increased transconductance of the input stage 110 after the dynamic frequency compensation, since the gain A_{EA} of the input stage 110 remains the same after the dynamic frequency compensation, this indicates that A_{EA}≅g_{mEA}r_{EA}≅g_{mEA}′r_{EA}′. The moved second pole ωp2′ after the dynamic frequency compensation can be expressed as:

$$ω p {2}^{′} = \frac{1}{{r}_{EA}^{′} \times {C}_{gg}} .$$

This indicates that the second pole ωp2′ of the LDO regulator 100A after the dynamic frequency compensation moves to a higher frequency compared to the original second pole ωp2 before the dynamic frequency compensation, as shown in FIG. 4C.

FIG. 5A illustrates Bode plots for the magnitude and phase with respect to the frequency in some frequency compensation approaches.

In some approaches, the technique of Miller compensation may be employed within a first LDO regulator, such as implementing a Miller capacitance between the output terminal of the LDO regulator and the output terminal of an input stage thereof. However, a Miller capacitor, fabricated in a back-end-of line (BEOL) of the manufacturing process, can occupy a large portion of the first LDO regulator. As such, the noise of the power supply voltage VDD is coupled into the first LDO regulator through the Miller capacitance path, such as from the output terminal of the first LDO regulator to the output terminal of the input stage thereof, increasing the PSRR (power supply rejection ratio) of the first LDO regulator. For example, the first LDO regulator implementing the Miller compensation technique may have a first pole ωp0 and a second pole ωp2, and the Bode plots of the magnitude and phase with respect to the angular frequency of the first LDO regulator are shown by curves 502 and 506 in FIG. 5A, respectively. For example, referring to curve 502 of the magnitude Bode plot (i.e., upper portion) of FIG. 5A, the magnitude of the first LDO regulator can be maintained at the overall gain DC_Gain1 until the first pole ωp0 (e.g., dominant pole) is met. Starting from the first pole ωp0, the magnitude decreases at a slew rate of −20 dB per decade (e.g., −20 dB/decade) until the second pole ωp2 is met. Starting from the second pole ωp2, the magnitude decreases at a slew rate of −40 dB per decade (e.g., −40 dB/decade). It should be noted that ωt denotes the angular frequency corresponding to the unity gain (i.e., gain=1 or 0 dB) of the first LDO regulator, and it also refers to the first bandwidth BW1 of the first LDO regulator (i.e., BW1=ωt). Referring to curve 506 of the phase Bode plot (i.e., lower portion) of FIG. 5A, the phase of the first LDO regulator can be maintained at 0 degrees until the first pole ωp0 is met. Starting from the first pole ωp0, the phase decreases at a slew rate of −45 degrees per decade (e.g., −45°/decade) until the second pole ωp2 is met. Starting from the second pole ωp2, the phase decreases at a slew rate of −90 degrees per decade (e.g., −90°/decade). It should be noted that the first LDO regulator may have a first phase margin PM1 at the angular frequency ωt.

In some other approaches, the technique using a heavy load capacitance may be employed within a second LDO regulator, indicating that the relatively large load capacitance of the load is used by the second LDO regulator. As described, the angular frequency of the first pole (or dominant pole) of the second LDO regulator can be calculated as

$$\frac{1}{{r}_{OUT} \times {C}_{L}} .$$

When a relatively large load capacitance CL is used, the angular frequency of the first pole moves to a higher angular frequency, such as the first pole ωp1 shown in the magnitude Bode plot (i.e., upper portion) of FIG. 5A. However, the second pole ωp2 of the second LDO regulator remains the same as the second pole ωp2 of the first LDO regulator using the Miller compensation technique, as shown by curve 504 in FIG. 5A. Referring to curve 504 of the magnitude Bode plot (i.e., upper portion) of FIG. 5A, the magnitude of the second LDO regulator can be maintained at the overall gain DC_Gain2, which is slightly lower than the overall gain DC_Gain1, until the first pole ωp1 (e.g., dominant pole) is met. Starting from the first pole ωp1, the magnitude decreases at a slew rate of −20 dB per decade (e.g., −20 dB/decade) until the second pole ωp2 is met. Starting from the second pole ωp2, the magnitude decreases at a slew rate of −40 dB per decade (e.g., −40 dB/decade). It should be noted that ωt′ denotes the angular frequency corresponding to the unity gain (i.e., gain=1 or 0 dB) of the second LDO regulator, and it also refers to the second bandwidth BW2 of the second LDO regulator (i.e., BW2=ωt′), which is larger than the first bandwidth BW1 of the first LDO regulator (i.e., BW1=ωt).

Referring to curve 508 of the phase Bode plot (i.e., lower portion) of FIG. 5A, since the angular frequency the first pole ωp1 of the second LDO regulator is higher than the first pole ωp0 of the first LDO regulator, the phase of the second LDO regulator can be maintained at 0 degrees until the first pole ωp1 is met. Starting from the first pole ωp1, the phase decreases at a slew rate of −45 degrees per decade (e.g., −45°/decade) until the second pole ωp2 is met. Starting from the second pole ωp2, the phase decreases at a slew rate of −90 degrees per decade (e.g., −90°/decade). It should be noted that the second LDO regulator may have a second phase margin PM2 at the angular frequency ωt′. As can be seen from the phase Bode plot in FIG. 5A, the second phase margin PM2 of the second LDO regulator is smaller than the first phase margin PM1 of the first LDO regulator.

FIG. 5B illustrates Bode plots for the magnitude and phase with respect to the frequency in accordance with the embodiments of FIGS. 2, 3A, and 4A.

As described above, the LDO regulator 100A after the dynamic frequency compensation may have a second pole ωp2′ with an angular frequency higher than the second pole ωp2 of the first LDO regulator or the second LDO regulator, as shown by curve 514 in the magnitude Bode plot (i.e., upper portion) of FIG. 5B. Additionally, the first pole ωp1 (e.g., dominant pole) of the LDO regulator 100A may be substantially equal to the first pole ωp1 of the second LDO regulator. Referring to curve 514 of the magnitude Bode plot (i.e., upper portion) of FIG. 5B, the magnitude of the LDO regulator 100A can be maintained at the overall gain DC_Gain2, which is slightly lower than the overall gain DC_Gain1, until the first pole ωp1 (e.g., dominant pole) is met. Starting from the first pole ωp1, the magnitude decreases at a slew rate of −20 dB per decade (e.g., −20 dB/decade) until the second pole ωp2′ is met. Starting from the second pole ωp2′, the magnitude decreases at a slew rate of −40 dB per decade (e.g., −40 dB/decade). It should be noted that ωt″ denotes the angular frequency corresponding to the unity gain (i.e., gain=1 or 0 dB) of the LDO regulator 100A, and it also refers to the third bandwidth BW3 (e.g., third unity-gain frequency or bandwidth) of the LDO regulator 100A (i.e., BW3=ωt″), which is larger than the first bandwidth BW1 (e.g., first unity-gain frequency or bandwidth) of the first LDO regulator (i.e., BW1=ωt) and the second bandwidth BW2 (e.g., second unity-gain frequency or bandwidth) of the second LDO regulator (i.e., BW2=ωt′). This indicates that the bandwidth of the LDO regulator 100A utilizing the dynamic frequency compensation have a wider bandwidth (e.g., higher unity-gain bandwidth) than the first LDO regulator and the second LDO regulator.

Referring to curve 518 of the phase Bode plot (i.e., lower portion) of FIG. 5B, the phase of the LDO regulator 100A can be maintained at 0 degrees until the first pole ωp1 is met. Starting from the first pole ωp1, the phase decreases at a slew rate of −45 degrees per decade (e.g., −45°/decade) until the second pole ωp2′ is met. Starting from the second pole ωp2′, the phase decreases at a slew rate of −90 degrees per decade (e.g., −90°/decade). It should be noted that the LDO regulator 100A may have a third phase margin PM3 at the angular frequency ωt″. As can be seen from the phase Bode plot in FIG. 5B, the third phase margin PM3 of the LDO regulator 100A is approximately equal to the first phase margin PM1 of the first LDO regulator, and is larger than the second phase margin PM2 of the second LDO regulator, indicating that the phase margin of the LDO regulator 100A can be maintained using the dynamic frequency compensation technique as described in the embodiments of FIGS. 2 to 4.

Therefore, the capacitor-less design (i.e., no Miller capacitor or external capacitor is used) of the LDO regulator 100A can avoid the direct coupling path of the noise of the power supply voltage, enhancing the PSRR of the LDO regulator 100A and reducing the layout area thereof. This can facilitate integrating the LDO regulator 100A to a system-on-chip (SoC). Additionally, the angular frequency of the second pole of the LDO regulator 100A can be adjusted using dynamic frequency compensation, which detects changes in the load current to compensate for the loop gain and phase margin, thereby maintaining wide bandwidth (e.g., BW3) and loop gain under heavy loading. Furthermore, the PSRR of the LDO regulator 100A is maintained due to its stable gain and bandwidth.

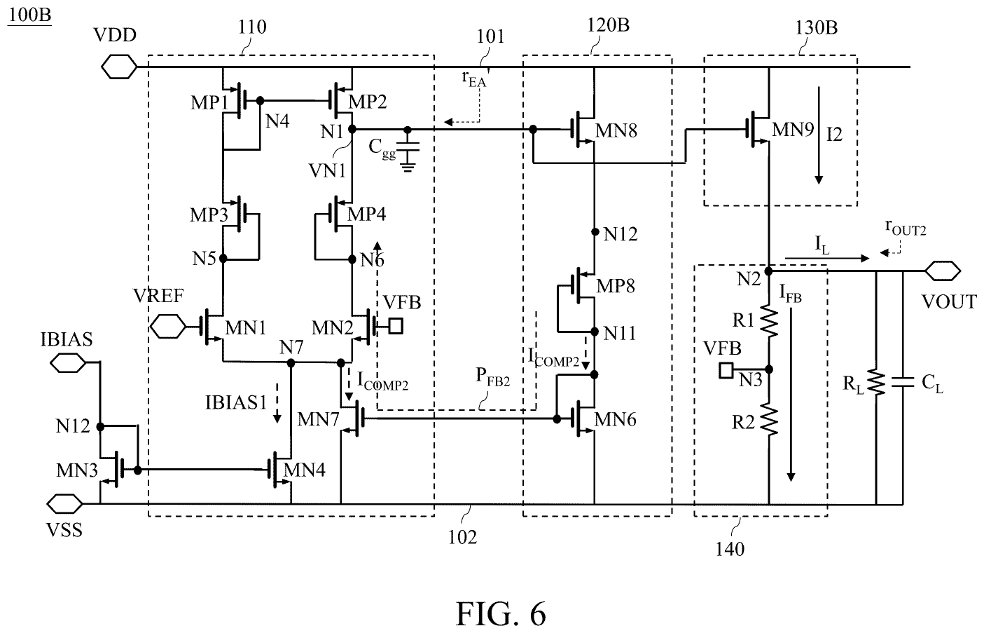

FIG. 6 is another schematic diagram of the low-dropout regulator in accordance with the embodiment of FIG. 1.

In some embodiments, the LDO regulator 100 shown in FIG. 1 can be implemented using the LDO regulator 100B shown in FIG. 6. The LDO regulator 100B shown in FIG. 6 may be similar to the LDO regulator 100A shown in FIGS. 2 to 4, with the difference being that the driving devices within the transconductance compensation stage 120B and the driving stage 130B are implemented using N-type transistors, such as MN8 and MN9, respectively, as depicted in FIG. 6. Additionally, there is one stage within the transconductance compensation stage 120B, which includes transistors MN6, MN8, and MP8, and the LDO regulator 100B does not have the third pole ωp3 compared to the LDO regulator 100A in FIGS. 2 to 4.

In some embodiments, the driving devices within the transconductance compensation stage 120B and the driving stage 130B of the LDO regulator 100B, such as transistors MN8 and MN9, include N-type transistors.

The analysis of the negative feedback loop within the LDO regulator 100B is described as follows. First, referring to FIG. 6, transistor MN9 in the driving stage 130B provides a fixed driving current I2 when activated, and current I2 equals the load current I_{L} plus the feedback current I_{FB}. When the load current I_{L} at the output terminal of the LDO regulator 100B increases, the feedback current I_{FB} decreases, which reduces the feedback voltage V_{FB} at node N3. Subsequently, the reference voltage VREF becomes higher than the feedback voltage V_{FB}, turning on transistor MN1 and turning off transistor MN2. Accordingly, the voltage at node N4 is pulled down through transistors MP3 and MN1, turning on transistor MP2 and thereby increasing the voltage VN1 at node N1, which is the first S/D terminal of transistor MP2 and the output terminal of the input stage 110. This indicates that the gate voltage of transistor MN8 within the transconductance compensation stage 120A increases with the voltage VN1.

It should be noted that a higher gate voltage (e.g., voltage VN1 at node N1) of transistor MN9 induces a higher drain voltage of transistor MN9, serving as the output voltage VOUT. Additionally, the feedback voltage V_{FB} at node N3 increases as the output voltage VOUT increases. The aforementioned operations constitute a negative feedback loop, starting from a decreased feedback voltage V_{FB} due to the increasing load current I_{L}, and resulting in an increased feedback voltage V_{FB}.

On the other hand, when the load current I_{L} at the output terminal of the LDO regulator 100B decreases, the feedback current I_{FB} increases, which increases the feedback voltage V_{FB} at node N3. Subsequently, the reference voltage VREF becomes lower than the feedback voltage V_{FB}, turning off transistor MN1 and turning on transistor MN2. Accordingly, the voltage at node N1 is pulled down through transistors MP4 and MN2, turning off transistor MP2 and thereby decreasing the voltage VN1 at node N1, which is the first S/D terminal of transistor MP2 and the output terminal of the input stage 110. This indicates that the gate voltage of transistor MN8 within the transconductance compensation stage 120B decreases with the voltage VN1.

It should be noted that a lower gate voltage (e.g., voltage VN1 at node N1) of transistor MN9 induces a lower drain voltage of transistor MN9, serving as the output voltage VOUT. Additionally, the feedback voltage V_{FB} at node N3 decreases as the output voltage VOUT decreases. The aforementioned operations constitute a negative feedback loop, starting from a increased feedback voltage V_{FB} due to the decreasing load current I_{L}, and resulting in an decreased feedback voltage V_{FB}.

More specifically, the compensation current I_{COMP2} generated by the frequency compensation loop within the transconductance compensation stage 120B is fed back to the input stage 110 via transistor MN7 (e.g., the second current source for the input stage 110) along the feedback path P_{FB2}, increasing the overall transconductance gₘ of the input stage 110. For example, the overall bias current for the differential amplifier within the input stage 110 becomes the bias current IBIAS1 plus the compensation current ICOMP2. Since the output resistance r_{EA}′ after the dynamic frequency compensation is inversely proportional to the overall transconductance gₘ, the output resistance r_{EA}′ of the input stage 110 decreases as the overall transconductance gₘ of the input stage 110 increases. The moved second pole ωp2′ after the dynamic frequency compensation can be expressed as:

$$ω p {2}^{′} = \frac{1}{{r}_{EA}^{′} \times {C}_{gg}} .$$

This indicates that the second pole ωp2′ of the LDO regulator 100B after the dynamic frequency compensation moves to a higher frequency compared to the original second pole ωp2 before the dynamic frequency compensation. Furthermore, the dominant pole ωp1 of the LDO regulator 100B can be expressed as:

$$ω p 1 = \frac{1}{{r}_{OUT} \times {C}_{L}} .$$

For example, considering the small-signal model of the LDO regulator 100B, the output resistance r_{OUT2} at the output terminal of the LDO regulator 100B can be expressed by formula (4) as follows.

$${r}_{OUT 2} = {r}_{o N 9} / / ( R 1 + R 2 ) / / {R}_{L} \qquad ( 4 )$$

Referring to formula (4), r_{oN9} denotes the small-signal output resistance of transistor MN9, and R_{L} denotes the load resistance of load 150. Since the load capacitance C_{L} of load 150 is relatively large, the angular frequency (e.g., in units of rad/sec) of the dominant pole ωp1 is higher than the dominant pole ωp0 of a first LDO regulator utilizing the Miller compensation technique with a Miller capacitance, the details of which can be referred to the embodiments of FIG. 5B.

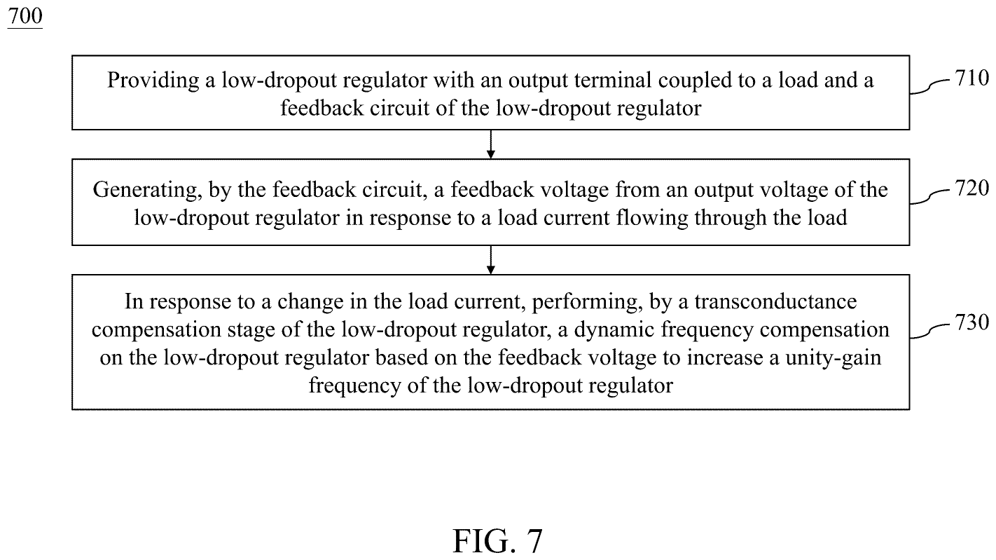

FIG. 7 is a flowchart of a method for operating a low-dropout regulator in accordance with some embodiments of the present disclosure. The sequence in which the operations of method 700 are depicted in FIG. 7 is for illustration only; the operations of method 700 are capable of being executed in sequences that differ from that depicted in FIG. 7. It is understood that additional operations may be performed before, during, and/or after the method 700 depicted in FIG. 7, and that some other processes may only be briefly described herein.

In operation 710, a low-dropout regulator 100 with an output terminal coupled to a load and a feedback circuit of the low-dropout regulator 100 is provided. In some embodiments, the LDO regulator 100 shown in FIG. 1 can be implemented using the LDO regulator 100A shown in FIG. 2 or the LDO regulator 100B shown in FIG. 6. Additionally, the LDO regulator 100 includes at least a first pole ωp1 (e.g., dominant pole) and a second pole ωp2, where ωp1<ωp2.

In operation 720, a feedback voltage V_{FB} is generated by the feedback circuit 140 from an output voltage of the low-dropout regulator 100 in response to a load current flowing through the load. In some embodiments, the LDO regulator 100 includes a negative feedback loop, which can detect changes in the load current to generate the corresponding feedback voltage V_{FB}. The output voltage (e.g., VN1) generated by the input stage 110 may vary depending on the change in the feedback voltage V_{FB}, and a compensation current may be induced within the transconductance compensation stage 120 based on the output voltage (e.g., VN1) of the input stage 110. The compensation current is mirrored and provided to the input stage 110, and the overall bias current of the input stage changes, such that the transconductance of the input stage 110 changes correspondingly.

In operation 730, in response to a change in the load current, a dynamic frequency compensation is performed on the low-dropout regulator, by a transconductance compensation stage 120 of the low-dropout regulator, based on the feedback voltage, to increase a unity-gain frequency of the LDO regulator 100. In some embodiments, since the output resistance of the input stage 110 is inversely proportional to its output resistance, decreases and increases in the transconductance of the input stage 110 can cause increases and decreases of the output resistance of the input stage 110 after the dynamic frequency compensation. Additionally, the dynamic frequency compensation is further configured to compensate for a loop gain and a phase margin of the low-dropout regulator 100 in response to the change in the load current.

An aspect of the present disclosure provides a voltage regulator circuit which includes an input stage, a transconductance compensation stage, a driving stage, and a feedback circuit. The input stage is configured to compare a reference voltage and a feedback voltage to generate a first voltage at a first output terminal of the input stage. The transconductance compensation stage is coupled between the first output terminal and an internal node of the input stage, and is configured to change an overall transconductance of the input stage in response to a change in the feedback voltage. The driving stage is coupled between the first output terminal and a second output terminal of the voltage regulator circuit, and is configured to provide a driving current to the second output terminal which is coupled to a load. The feedback circuit is coupled to the second output terminal, and is configured to generate the feedback voltage based on an output voltage of the voltage regulator circuit.

Another aspect of the present disclosure provides a voltage regulator circuit which includes an input stage, a dynamic frequency compensation stage, a driving stage, and a feedback circuit. The input stage is configured to compare a reference voltage and a feedback voltage to generate a first voltage at a first output terminal of the input stage. The dynamic frequency compensation stage is coupled between the first output terminal and an internal node of the input stage, and is configured to perform a dynamic frequency compensation based on the feedback voltage to increase a unity-gain frequency of the voltage regulator circuit in response to a change in a load current of a load coupled to a second output terminal of the voltage regulator circuit. The driving stage is coupled between the first output terminal and the second output terminal, and is configured to provide a driving current to the second output terminal. The feedback circuit is coupled to the second output terminal, and is configured to generate the feedback voltage based on an output voltage of the voltage regulator circuit.

Yet another aspect of the present disclosure provides a method. The method includes the following steps: providing a low-dropout regulator with an output terminal coupled to a load and a feedback circuit of the low-dropout regulator; generating, by the feedback circuit, a feedback voltage from an output voltage of the low-dropout regulator in response to a load current flowing through the load; and in response to a change in the load current, performing, by the low-dropout regulator, a dynamic frequency compensation based on the feedback voltage to increase a unity-gain frequency of the low-dropout regulator.

The methods and features of the present disclosure have been sufficiently described in the provided examples and descriptions. It should be understood that any modifications or changes without departing from the spirit of the present disclosure are intended to be covered in the protection scope of the present disclosure.

Moreover, the scope of the present application is not intended to be limited to the particular embodiments of the process, machine, manufacture, and composition of matter, means, methods and steps described in the specification. As those skilled in the art will readily appreciate from the present disclosure, processes, machines, manufacture, composition of matter, means, methods or steps presently existing or later to be developed, that perform substantially the same function or achieve substantially the same result as the corresponding embodiments described herein, can be utilized according to the present disclosure.

Accordingly, the appended claims are intended to include within their scope processes, machines, manufacture, compositions of matter, means, methods or steps. In addition, each claim constitutes a separate embodiment, and the combination of various claims and embodiments are within the scope of the present disclosure.

1. A voltage regulator circuit, comprising:
an input stage, configured to compare a reference voltage and a feedback voltage to generate a first voltage at a first output terminal of the input stage;
a transconductance compensation stage, coupled between the first output terminal and an internal node of the input stage, and configured to change an overall transconductance of the input stage in response to a change in the feedback voltage;
a driving stage, coupled between the first output terminal and a second output terminal of the voltage regulator circuit, and configured to provide a driving current to the second output terminal which is coupled to a load; and
a feedback circuit, coupled to the second output terminal, and configured to generate the feedback voltage based on an output voltage of the voltage regulator circuit.

2. The voltage regulator circuit of claim 1, wherein the input stage is implemented using a differential amplifier, an operational amplifier, or an operational transconductance amplifier.

3. The voltage regulator circuit of claim 2, wherein the transconductance compensation stage is further configured to generate a compensation current based on the first voltage generated by the input stage, and provide the compensation current to the input stage in addition to a bias current of the input stage.

4. The voltage regulator circuit of claim 3, wherein the driving current is divided into a load current flowing into the load and a feedback current flowing through the feedback circuit.

5. The voltage regulator circuit of claim 4, wherein the feedback circuit is implemented using a voltage divider with a feedback factor, and the feedback voltage is obtained by multiplying the output voltage with the feedback factor.

6. The voltage regulator circuit of claim 5, wherein the input stage comprises a first input terminal receiving the reference voltage and a second input terminal receiving the feedback voltage, and the input stage is biased by the bias current plus the compensation current.

7. The voltage regulator circuit of claim 6, wherein the transconductance compensation stage comprises:
a first stage, coupled to the first output terminal, and biased by the bias current; and
a second stage, coupled to the first stage, and configured to generate the compensation current based on a second voltage generated by the first stage.

8. The voltage regulator circuit of claim 7, wherein the driving stage is further configured to generate the driving current based on the second voltage generated by the first stage.

9. The voltage regulator circuit of claim 8, wherein driving devices of the first stage, the second stage, and the driving stage comprise P-type transistors.

10. The voltage regulator circuit of claim 6, wherein the transconductance compensation stage is further configured to generate the compensation current based on the first voltage generated by the input stage, and the driving stage is further configured to generate the driving current based on the first voltage generated by the input stage.

11. The voltage regulator circuit of claim 10, wherein driving devices of the transconductance compensation stage and the driving stage comprise N-type transistors.

12. The voltage regulator circuit of claim 1, wherein:
the voltage regulator circuit comprises a first pole at a first frequency and a second pole at a second frequency;
the first frequency is lower than the second frequency;
the first pole is a dominant pole; and
the transconductance compensation stage is configured to perform a dynamic frequency compensation in response to a change in the load current to move the second pole to a third frequency higher than the second frequency.

13. The voltage regulator circuit of claim 12, wherein the first pole is associated with a first output resistance and a load capacitance of the load at the second output terminal of the voltage regulator circuit, and the second pole is associated with a second output resistance and an equivalent parasitic capacitance at the first output terminal of the input stage.

14. A voltage regulator circuit, comprising:
an input stage, configured to compare a reference voltage and a feedback voltage to generate a first voltage at a first output terminal of the input stage;
a dynamic frequency compensation stage, coupled between the first output terminal and an internal node of the input stage, and configured to perform a dynamic frequency compensation based on the feedback voltage to increase a unity-gain frequency of the voltage regulator circuit in response to a change in a load current of a load coupled to a second output terminal of the voltage regulator circuit, wherein the dynamic frequency compensation stage includes at least one transistor;
a driving stage, coupled between the first output terminal and the second output terminal, and configured to provide a driving current to the second output terminal; and
a feedback circuit, coupled to the second output terminal, and configured to generate the feedback voltage based on an output voltage of the voltage regulator circuit.

15. The voltage regulator circuit of claim 14, wherein dynamic frequency compensation stage does not include a capacitor.

16. The voltage regulator circuit of claim 14, wherein the feedback circuit is implemented using a voltage divider with a feedback factor, and the feedback voltage is obtained by multiplying the output voltage with the feedback factor.

17. The voltage regulator circuit of claim 16, wherein:
the plurality of poles comprise a first pole at a first frequency and a second pole at a second frequency;
the first frequency is lower than the second frequency;
the first pole is a dominant pole; and
the dynamic frequency compensation stage is configured to perform the dynamic frequency compensation in response to the change in the load current to move the second pole to a third frequency higher than the second frequency.

18. The voltage regulator circuit of claim 17, wherein the first pole is associated with a first output resistance and a load capacitance at the second output terminal of the voltage regulator circuit, and the second pole is associated with a second output resistance and an equivalent parasitic capacitance at the first output terminal of the input stage.

19. A method, comprising:
providing a low-dropout regulator with an output terminal coupled to a load and a feedback circuit of the low-dropout regulator;
generating, by the feedback circuit, a feedback voltage from an output voltage of the low-dropout regulator in response to a load current flowing through the load; and
in response to a change in the load current, performing, by a dynamic frequency compensation stage in the low-dropout regulator, a dynamic frequency compensation based on the feedback voltage to increase a unity-gain frequency of the low-dropout regulator, wherein the dynamic frequency compensation stage comprises at least one transistor.

20. The method of claim 19, wherein the dynamic frequency compensation is further configured to compensate a loop gain and a phase margin of the low-dropout regulator in response to the change in the load current.
